(19) United States
(12) Patent Application Publication
(10) Pub. No.: US 2014/0365266 A1
(43) Pub. Date: Dec. 11, 2014

(54) ENTERPRISE PROCESS EVALUATION

(71) Applicant: TATA CONSULTANCY SERVICES LIMITED, Mumbai (IN)

(72) Inventors: Rajesh Sethi, Bangalore (IN); Ramaswamy Srinivasaiah Raghavendra, Bangalore (IN)

(21) Appl. No.: 14/295,907

(22) Filed: Jun. 4, 2014

(30) Foreign Application Priority Data
Jun. 5, 2013 (IN) 1951/MUM/2013

(51) Int. Cl. G06Q 10/06

(52) U.S. Cl. CPC G06Q 10/0633
USPC 705/7.27

(57) ABSTRACT

Method and system for performing an evaluation of an enterprise process. The method includes receiving process data for a plurality of activities associated with the at least one enterprise process. The process data depicts a current state of the at least one enterprise process. Based on the process data, a plurality of lean metrics for each of the plurality of activities is calculated. Upon calculating the plurality of lean metrics, a lean maturity assessment is performed to evaluate the enterprise process by comparing the current state of the enterprise process with a target state of the enterprise process based at least on the process data and target data depicting the target state of the enterprise process.

### TECHNICAL FIELD

The present subject matter relates, in general, to evaluation of a process, and particularly, but not exclusively to, performing evaluation of an enterprise process.

### BACKGROUND

Enterprise processes typically refer to series of business activities, which are carried out for achieving business objectives. In the present day, many processes in enterprises have been either completely or partially automated. The automation of enterprise processes helps the enterprises to improve efficiency. Generally, the automation may be provided by various information technology (IT) systems, such as an Enterprise Resource Planning (ERP) system and other applications. To continuously optimize the enterprise processes and effectively use resources, the enterprise processes including IT systems are often evaluated and optimized by the enterprise according to align to changing business priorities and future needs.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1a illustrates a network environment implementing a process evaluation system, in accordance with an embodiment of the present subject matter.

FIGS. 1b, 1c, 1d, and 1e illustrate sample data generated by the process evaluation system, in accordance with an embodiment of the present subject matter.

FIG. 2 illustrates a method for performing enterprise process evaluation, in accordance with an embodiment of the present subject matter.

### DETAILED DESCRIPTION

Method and system for performing evaluation of an enterprise process pertaining to a business are described herein. With the increasing use of information technology, present enterprises are automating business processes, hereinafter referred to as enterprise processes, either completely or partially to improve efficiency. Examples of such enterprise processes include processing of insurance claim applications, processing of incentives given to employers, and processing of patient medical bills. The automation may be provided by various information technology (IT) systems, such as an Enterprise Resource Planning (ERP) system and customized web-based applications. Typically, the enterprises continuously evaluate the enterprise processes for optimizing the enterprise processes and enhancing the existing IT systems within the enterprise according to changing business objectives and business priorities. For instance, the enterprises may evaluate the enterprise processes for identifying weakness or bottle necks and standardizing multiple parallel processes performed by different business units of the enterprise. Conventionally, various techniques are used for evaluating the enterprise processes. Such techniques capture process data of the enterprise processes and evaluate the enterprise process for optimization of business. Examples of such techniques include As-Is Process, suppliers-inputs-process-outputs-customers (SIPOC) analysis, volumetric, service level agreements (SLA) analysis, value stream map (VSM) analysis, and failure mode and effect analysis (FMEA).

These techniques typically use multiple standard and non-standard templates for capturing process data, such as actual head count, turnaround time, error count, input forms, and output forms related to the enterprise process. Based on the process data, a current state of the enterprise process is evaluated that provides a clear view of working of the enterprise process when the process data was captured. Thereafter, improvements are suggested based on the evaluation. In one example, the improvements may necessitate minor modifications to the enterprise processes, such as providing facility to capture more data in the existing IT systems. In another example, the improvements may necessitate reengineering of the enterprise processes and design of new IT system.

However, these techniques operate independently of each other. Therefore, more time and resources are consumed for gathering specific process data necessary for each technique. Also, these techniques are used for evaluating specific enterprise processes. For example, SLA Analysis is mainly used for web services. Further, these techniques do not provide a provision of importing process data captured by other techniques. Also, these techniques do not provide a provision for importing the analysis performed by other techniques. The current techniques are thus largely time consuming and resource intensive techniques. Furthermore, the process data captured for plurality of activities by the different techniques are not synchronized with each other for further analysis. Also, an analysis of the process data captured by these techniques do not provide a clear view of resource utilization by all the activities of the enterprise process. Moreover, a user is not able to visualize how process metrics are influencing specific business metrics based on the analysis provided by these techniques. For example, the user may not be able to visualize how a process metric “cycle time” can positively or negatively influence a business metric like “Cost of a Transaction” or “Customer satisfaction”.

According to an embodiment of the present subject matter, a method and a system for performing evaluation of an enterprise process pertaining to a business are described herein. A process evaluation system is configured to receive process data corresponding to the enterprise process and analyze the process data for optimization of the enterprise process according to changing business objectives and business priorities. For the purpose, the process evaluation system receives process data corresponding to the enterprise process and maps the process data with a plurality of activities associated with the enterprise process. In one implementation, the process data may be defined as data depicting a current state of the enterprise process. It would be understood, that the current state of the enterprise process provides a clear view of actual or present working condition of the enterprise process when the process data was captured.

The process evaluation system may further calculate a plurality of lean metrics based on the process data. As would be understood, lean is a business methodology to identify wasteful practices, reduce costs, and increase quality of an enterprise process. Therefore, a user defines the lean metrics to objectively identify the wasteful practices of the enterprise process in terms of resources and activities employed in the enterprise process. Examples of the plurality of lean metrics include full time equivalent (FTE), input volume per month, touch points per unit of output volume, turn around time, actual defect count per month, value added (VA) activities, non-value added (NVA) activities, business non value added (BNVA) activities, regulatory non-value added (RVNA) activities, and unutilized FTE. The plurality of lean metrics may defined as parameters for measuring performance of the enterprise process in numerical terms to identify weakness and to facilitate immediate improvements for optimizing the enterprise process.

Further, the process evaluation system may perform a lean maturity assessment of the enterprise process by comparing the current state of the enterprise process with a target state of the process. The target state of the enterprise process may be defined as a future condition of the enterprise process achieving the changed business objectives and business priorities after implementing improvements. In one implementation, the process evaluation system performs the lean maturity assessment based on the process data and a target data depicting the target state of the process. The lean maturity assessment of the enterprise process enables a user to objectively assess the current state of the enterprise process, implemented process improvements, and commitment and engagement of business users towards the implemented process improvement. The lean maturity assessment of the enterprise process also enables the user to identify potential improvements required for achieving the target state of the enterprise process.

Further, the process evaluation system may generate a value steam analysis chart and performance assessment charts based on the process data and the calculated plurality of lean metrics. Examples of such performance assessment charts include cycle time per unit, value added (VA) FTE analysis chart, non-value added (NVA) FTE analysis chart, and so on. As would be understood, the value stream analysis map may be used for analyzing and designing a flow of materials, transaction and information required for bringing a product or service to a an end customer. Similarly, the performance assessment charts, such as the VA FTE analysis chart may be used for streamlining the enterprise process to manufacture and delivery of a product or service according to the end customer's needs and requirements. Therefore, the process evaluation system enables the user to evaluate the enterprise process based on the received process data, the calculated lean metrics, and the value stream analysis map and performance assessment charts. The process evaluation system further enables the user to develop robust solutions by establishing clear linkages to process pain areas both at a tactical and at strategic levels while meeting the business objectives.

The present subject matter thus provides a method and a system for performing evaluation of an enterprise process pertaining to a business. Thus, a significant number of documentations, such as infrastructure and applications capture documentations, skill set information capture documentations, training needs or Knowledge Transfer timelines, and process information related documentations are received by a single system as the system provides a single platform for capturing all the data related to the business, such as IT infrastructure needed, existing IT systems, present method of doing business, and skill set/certifications requirement of business users required for doing the business. Thereby, standardizing a process for capturing process data and synchronizing the captured data for enterprise process evaluation that enables creation of distilled information required to identify wastes and prioritize improvements. Also, the single system enables capturing all the information necessary for enterprise process evaluation and provides meaningful insights in a short span of time. Also, the system enables calculating an exhaustive list of performance metrics that can be analyzed to meet business objectives. Further, a significant number of transitional deliverables, such as As-Is process maps, FTE estimation, value stream maps, and analysis charts are provided through the single system, thereby enabling a user to objectively assess the enterprise process, identify and prioritize improvements, and develop robust business off shoring (transition) and business process transformation solutions. Further, the system enables capturing of data related to the enterprise process at a fine grained level thereby enabling the user to visualize and understand a comprehensive picture of the business in current state. Also, the system reduces the time needed in capturing data and generating above mentioned deliverables.

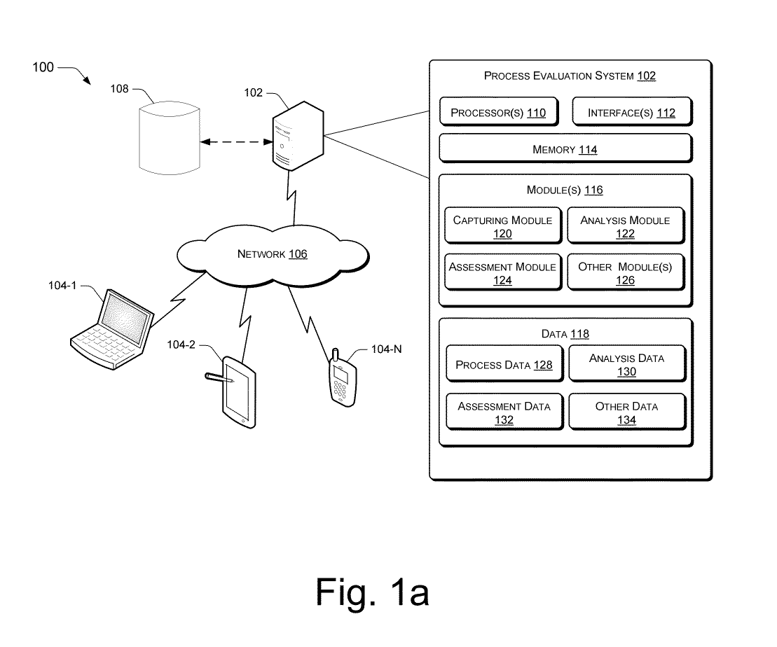

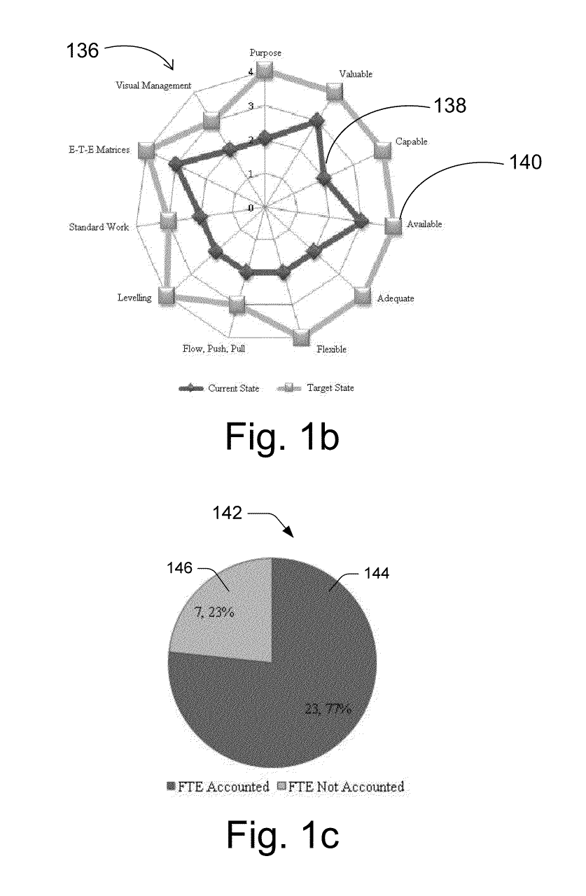

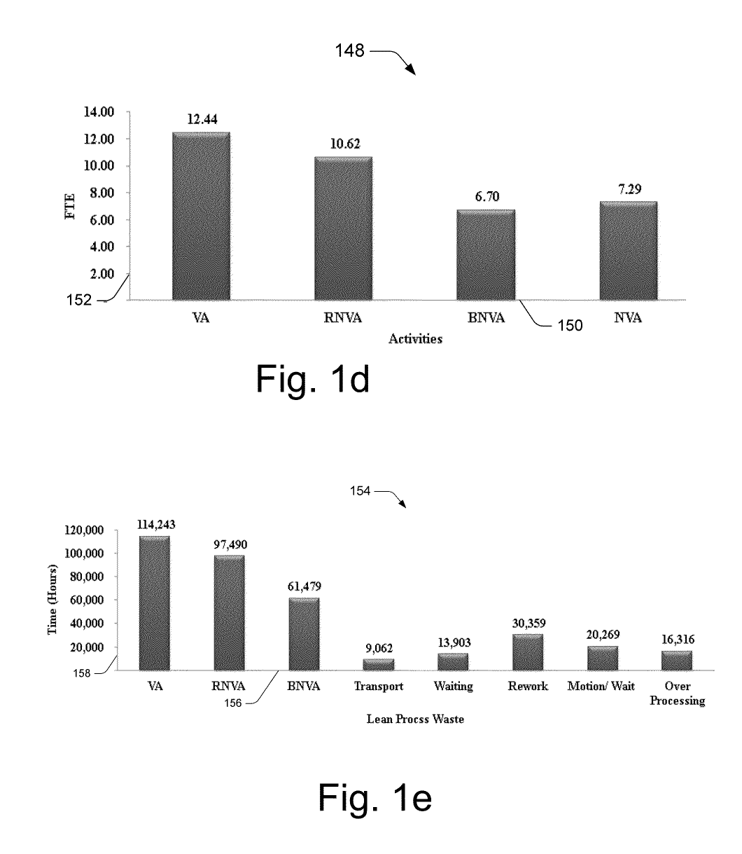

The manner in which the systems and methods for performing evaluation of an enterprise process pertaining to a business are implemented is explained in detail with respect to FIGS. 1a, to 2. While aspects of described systems and methods for performing evaluation of the enterprise process may be implemented in any number of different computing systems, environments, and/or configurations, the embodiments are described in the context of the following system(s).

FIG. 1a illustrates a network environment 100 implementing a process evaluation system 102 for performing evaluation of an enterprise process pertaining to a business, in accordance with an embodiment of the present subject matter. The process evaluation system 102 is communicatively coupled to user devices 104-1, 104-2, . . . , 104-N, through a network 106. For the sake of clarity, the user devices 104-1, 104-2, . . . , 104-N are collectively referred to as the user devices 104 and individually referred to as the user device 104. Examples of the user devices 104 include, but are not restricted to, desktop computers, laptops, smart phones, personal digital assistants (PDAs), tablets, and the like.

The user devices 104 are communicatively coupled to the process evaluation system 102 over the network 106 through one or more communication links, for example, via dial-up modem connections, cable links, and digital subscriber lines (DSL), wireless or satellite links, or any other suitable form of communication through the network 106. The network 106 may be a wireless network, a wired network or a combination thereof. The network 106 may be implemented as one of the different types of networks, such as intranet, local area network (LAN), wide area network (WAN), cloud based network, and the internet.

Examples of the process evaluation system 102 may include, but are not restricted to, servers, workstations, computers, laptops, smart phones, personal digital assistants (PDAs), tablets, and the like. In one implementation, the process evaluation system 102 may be accessed for evaluating an enterprise process pertaining to a business by receiving process data related to the enterprise process from a user. The user may be a management consultant from a consulting firm hired for evaluating the enterprise process. In one implementation, a document, such as a spreadsheet may be downloaded from the process evaluation system 102 onto the user device 104 for receiving the process data from the user. In another implementation, a web application hosted on the process evaluation system 102 may be accessed through the user device 104 for receiving the process data from the user. In one another implementation, an application may be downloaded from the process evaluation system 102 onto the user device 104. In one example, the user, such as the management consultant is tasked with performing evaluation of enterprise process pertaining to a client business. The user may then access either the document or the web application from the process evaluation system 102 through the user device 104 either at a client business location or at any other location. The user may then interview business users during workshops and interview sessions for gathering the process data using a template provided by the document or the web application and providing the process data to the process evaluation system 102 through the user device 102. Upon receiving the process data, the process evaluation system 102 may calculate a plurality of lean metrics and perform lean maturity assessment for evaluating the enterprise process to identify weaknesses in the enterprise process and to facilitate immediate improvements for optimizing the enterprise process. Further, the process evaluation system 102 may be communicatively coupled to a database 108 for storing the process data and other data pertaining to evaluation of the enterprise process for future references.

Further, the process evaluation system 102 includes processor(s) 110, interface(s) 112, and a memory 114 coupled to the processor(s) 110. The interface(s) 112 may include a variety of application programs and hardware interfaces, for example, a network interface allowing the process evaluation system 102 to interact with the user devices 104 and the database 108. The interface(s) 112 may also facilitate multiple communications within a wide variety of networks and protocol types, including wired networks, for example, LAN, cable, etc., and wireless networks, such as WLAN, cellular, and satellite networks.

The processor(s) 110 may be implemented as one or more microprocessors, microcomputers, microcontrollers, digital signal processors, central processing units, state machines, logic circuitries, and/or any devices that manipulate signals based on operational instructions. Among other capabilities, the processor(s) 110 is configured to fetch and execute computer-readable instructions and data stored in the memory 114.

The memory 114 may include any non-transitory computer-readable medium known in the art including volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

In one implementation, the process evaluation system 102 may include module(s) 116 and data 118. The module(s) 116, amongst other things, include routines, programs, objects, components, data structures, etc., which perform particular tasks or implement data types. The module(s) 116 may also be implemented as, signal processor(s), state machine(s), logic circuitries, and/or any other device or component that manipulate signals based on operational instructions.

Further, the module(s) 116 may be implemented in hardware, instructions executed by a processing unit, or by a combination thereof. The processing unit may comprise a computer, a processor, such as the processor(s) 110, a state machine, a logic array or any other suitable devices capable of processing instructions. The processing unit may be a general-purpose processor which executes instructions to cause the general-purpose processor to perform the required tasks or, the processing unit may be dedicated to perform the required functions.

In another aspect of the present subject matter, the module(s) 116 may be machine-readable instructions (software) which, when executed by a processor/processing unit, perform any of the described functionalities. The machine-readable instructions may be stored on an electronic memory device, hard disk, optical disk or other machine-readable storage medium or non-transitory medium. In one implementation, the machine-readable instructions may also be downloaded to the storage medium via a network connection.

In one implementation, the module(s) 116 further include a capturing module 120, an analysis module 122, an assessment module 124, and other module(s) 126. The other module(s) 126 may include programs or coded instructions that supplement applications and functions of the process evaluation system 102. The data 118 serves, amongst other things, as a repository for storing data processed, received, and generated by one or more of the other module(s) 126. The data 118 includes access process data 128, analysis data 130, assessment data 132, and other data 134. The other data 134 includes data generated as a result of the execution of one or more modules in the other module(s) 126.

As previously described, the process evaluation system 102 may be accessed for evaluating an enterprise process pertaining to a business. For this purpose, the capturing module 120 may receive process data related to the enterprise process from the user during workshops and interviews with business users through a template. Examples of the process data include, but are not limited to, end-to-end business metrics, actual headcount, inventory, turn around time (TAT), service level agreements (SLA), process input information, such as volume, measure of input volume, input and output forms used, defect rate, activity input information (volume and measure of input volume), process improvement opportunities in people, process, and technology area, infrastructure, skill set of people, training needs of people, timelines for trainings, and timelines for knowledge transfer. In an implementation, the capturing module 120 may provide a document, such as the spreadsheet to the user for receiving the process data. In another implementation, the capturing module 120 may provide the web application to the user for receiving the process data 128.

Further, the capturing module 120 may divide the enterprise process into different levels of hierarchy such that the enterprise process is defined by a plurality of activities. The capturing module 120 may then map the process data to the plurality of activities associated with the enterprise process thereby capturing details of the enterprise process at fine-grained level. In one example, the enterprise process may be divided in a three level hierarchy such that each sub-process of the enterprise process is defined by the plurality of activities and each of the activities is defined by at least one step. For example, an enterprise process pertaining to settlement of insurance claims may have various sub-processes, such as submission of claim application, docketing the claim application, and underwriting of the claim application. The sub-process submission of claim application may be defined by the plurality of activities, such as online submission and paper submission. The user may receive the process data pertaining to the plurality of activities, such as what type of input forms are used for online submission and paper submission, what is the volume of claim applications submitted via online submission and paper submission, what type of output forms used for providing acknowledgment of receiving claim applications, and what is the turn around time for acknowledging the receiving of claim applications.

In one implementation the capturing module 120 may receive the process data for a predetermined time period, such as one year, one quarter, and a half year. The process data received for the predetermined time period depicts a current state of the enterprise process during the predetermined time period. As would be understood, the current state provides a clear view of actual or present working condition of the enterprise process during the predetermined time period. The process data thus received by the capturing module 120 may be stored as the process data 128.

The capturing module 120 may further receive business data from the user through a template for understanding an end customer to whom a product or a service is delivered using the enterprise process. For the purpose, the user may interview the business users during workshops and interviews sessions for gathering the business data. The business data may further be used to analyze key end-to-end business metrics that the enterprise process is impacting and corresponding values of the end-to-end metrics. End-to-end business metrics may be defined as data about the enterprise process which is being analyzed and optimized. Examples of end-to-end business metrics for an enterprise process pertaining to settlement of insurance claims include, but are not limited to, policy issuance name, target rate, TAT, count of backdate errors, and not-in-good-order (NIGO). The business data received by the capturing module 120 may be further stored as the process data 128.

The capturing module 120 may further receive waste data from the user through a template pertaining to Lean Process wastes. For this purpose, the user may interview the business users during workshops and interviews sessions for gathering the waste data and providing to the capturing module 120. The identification of Lean Process wastes enables the user to identify any step or activity in the enterprise process that does not add value to the product or service as per the end customer requirement. In one implementation, the waste data may be received for each of the plurality of activities associated with the enterprise process. Examples of such Lean Process wastes include, but are not limited to, regulatory non-value adding activities (RVNA), Business non value adding activities (BNVA), transport, rework, people motion, and over-processing. RNVA may be defined as activities undertaken to comply with compliance regulation. BNVA may be defined as activities needed to support the quality of deliverable. Transport may be defined as transactions moving between business users and IT systems. Waiting may be defined as a transaction waiting to get processed at an activity level or to be allocated for processing. Rework may be defined as errors resulting in the transaction to rework for correction. People Motion may be defined as business users and activities moving back and forth and not in a linear forward motion. Over-processing may be defined as unnecessary activities performed to provide a product or service that increase the cost to the business even though the unnecessary activities do not add any value to the end customer. For example, generating a 30 page report when a short 2 page executive summary would have sufficed. The waste data received by the capturing module 120 may be further stored as the process data 128.

Further, the capturing module 120 may receive scoring data related to the current state of the enterprise process and a target state of the enterprise process for performing a lean maturity assessment of the enterprise process. As described above, the current state provides a clear view of actual or present working condition of the enterprise process during a predetermined time period. The target state may be defined as future condition of the enterprise process after optimization. The lean maturity assessment is performed by comparing the current state with the target state of the enterprise process to determine if the enterprise process is effective and to identify improvements as required. In one implementation, the capturing module 120 may receive a current scoring for the current state of the enterprise process and a target scoring for target state of the enterprise process based on lean assessment parameters. Examples of the lean assessment parameters include, but are not limited to, purpose, valuable, capable, available, adequate, flexible, leveling, standard work, end-to-end matrices, visual management, and flow, pull, push. Purpose may be defined as end objective of the enterprise process, such as solving problems of the end customer. Valuable may be defined value of the enterprise process as judged by the end customer. Capable may be defined as effectiveness of the enterprise process in providing satisfying results to the end customer. The enterprise process is rated on a scale of 1-to-4 scoring level for each of the lean assessment parameters, where 1 represents the lowest level of scoring and 4 is best in class scoring. The scoring criteria facilitate the user in accurately determining the level of the enterprise process for each lean assessment parameter. Table 1 below provides detailed guidelines to rate the enterprise process for each of the lean assessment parameters. Column ‘Parameter’ provides a list of lean assessment parameters. Columns ‘Level 1’, ‘Level 2’, ‘Level 3’, and ‘Level 4’ provides guidelines for rating the enterprise process, where ‘Level 1’ represents the lowest level of scoring and ‘Level 4’ represents the highest level of scoring’. For example, an enterprise process may be rated as ‘1’ for a parameter ‘Valuable’ if most of the steps in the enterprise process are non-value added as judged by an end customer. On the other hand, the enterprise process may be rated as ‘4’ for the parameter ‘Valuable’ if most of the steps in the enterprise process are value added as judged by the end customer.

TABLE 1

| Parameter | Level 1 | Level 2 | Level 3 | Level 4 |
|---|---|---|---|---|
| Purpose | The middle | The middle | The middle | The team at all |
| | management does | management | management | levels understands |
| | not understand | only | understands end to | the E-T-E Value |
| | who the end | understands | end value stream | Stream collaborates |
| | customer is and | upstream and | and collaborate | with up stream and |
| | their needs or | downstream but | with upstream and | downstream teams |
| | problems. | operate in silo. | downstream teams | and is empowered |
| | | | to address | to address customer |
| | | | customer needs | needs and |
| | | | and problems. | problems. |
| Valuable | Entire process or | Majority of | Most of the steps | The process steps |
| | most of the steps | steps (>50% in | are value adding or | are value adding as |
| | (>80% in terms of | terms of time | RNVA (>80% in | judged by end |
| | time and | and resources) | terms of time and | customer, the VA |
| | resources) are | are NVA as | resources) as | steps are automated |
| | NVA as judged by | judged by end | judged by end | where they may be |
| | end customer. | customer. There | customer. There | (basis a business |
| | There is very little | are significant | are opportunities | case). The |
| | or no automation. | opportunities to | for further | exceptions could be |
| | | further | automation of VA | regulatory NVA |
| | | automate and | and NVA steps | steps. |
| | | simplify. | (basis a business | |
| | | | case). | |
| Capable | Frequent customer | Significant | Opportunity for | The process steps |
| | escalations. | defect rate, high | Poke yoke. | produce good |
| | | rework, high | Minimal defects, | results every time. |
| | | TAT misses, | minimal rework, | No input |
| | | high Customer | minimum TAT | rejects/delays, no |
| | | Required Date | misses, and | rework, no misses |
| | | (CRD) misses. | minimum CRD | on TAT, no output |
| | | Occasional | misses. | errors, no misses on |
| | | customer | | end customer |
| | | escalations. | | required date. Fool |
| | | | | proof system where |
| | | | | ever possible. |
| Available | Significant time | Some time and | Minimal time and | System, software, |
| | and resource lost | resource lost | resource lost due | network, other infra |
| | due to | due to | to unavailability of | available as per |
| | unavailability of | unavailability of | system, software, | design during |
| | system, software, | system, | network and other | normal operating |
| | network and other | software, | infrastructure | conditions, ready |
| | infrastructure. | network and | during normal | for use whenever |
| | No BCP in place. | other | operating | needed. |
| | | infrastructure | condition. | BCP exists and |
| | | during normal | BCP exists but no | regularly tested. |
| | | operating | rigor and rhythm. | |
| | | conditions. | | |
| | | BCP exists but | | |
| | | never tested. | | |
| Adequate | Significant | Some | Minimal | Just enough |
| | over/under | over/under | over/under | capacity (no |
| | utilization of | utilization of | utilization of | slack/stretch) in |
| | capacity. | capacity. | capacity. | people and |
| | Hiring/removal of | Hiring/removal | Incremental | infrastructure. |
| | people and | of people and | hiring/removal of | Incremental |
| | investments in | investments in | people and | hiring/removal of |
| | systems/infrastructure | systems/infrastructure | investments in new | people. |
| | based on | based on | systems/infrastructure, | Incremental |
| | forecast volumes. | forecast | or based on | investments in new |
| | | volume. | committed | systems/infrastructre. |
| | | | volumes. | |
| Flexible | Inability to switch | Ability to | Ability to switch | Ability to switch |
| | between | switch between | between | between |
| | tasks/products. | tasks/products | tasks/products | tasks/products |
| | Separate | (variants) but | (variants) at a cost | (variants) quickly |
| | teams/capacity to | after a lengthy | and/or time delay. | and at a low cost. |
| | handle different | delay. | Teams are cross | |
| | tasks/products | Teams are cross | trained and utilized | |
| | (variants). | trained; | regularly for all | |
| | | however cross | tasks/products | |
| | | trained resource | (variants). | |
| | | isn't the first | | |
| | | option for | | |
| | | processing the | | |
| | | task/product | | |
| | | (variant). | | |
| Flow, Pull, | The linkage | The linkage | The linkage | The linkage |
| Push | between process | between process | between process | between process |
| | steps is not | steps is not | steps are optimally | steps is well |
| | coordinated: | optimally | defined but not | coordinated. |
| | neither laid out | defined. | rigorously | Where possible the |
| | adjacent and | | followed in the | transaction/material |
| | neither in process | | context of | ‘flows’ through |
| | sequence | | prioritization/‘pull’. | process steps that |
| | nor in the | | | are laid out adjacent |
| | transaction/material | | | and in process |
| | is pulled for | | | sequence, |
| | processing based | | | especially where |
| | on requirements of | | | judgment is |
| | the end | | | involved. |
| | customer/downstream | | | Alternatively the |
| | step. | | | transaction/material |
| | There is no | | | is |
| | prioritization done. | | | ‘pulled’/prioritized |
| | | | | for processing at |
| | | | | each step basis the |
| | | | | requirements of |
| | | | | downstream step |
| | | | | (when flow is |
| | | | | impossible). |
| Leveling | Volume forecast is | Incorrect | Incorrect forecasts | Volume forecast |
| | not cascaded to | forecasts (or | (or forecasts not | are cascaded to all |
| | any upstream | forecasts not | followed | upstream processes. |
| | processes. | followed) | rigorously) | Defined process to |
| | Therefore, the | resulting in | resulting in | assign special |
| | links between | frequent | occasional volume | projects, trainings |
| | process steps are | slack/stretch in | variations | during slack |
| | not coordinated | most process | (slack/stretch) in | periods. |
| | through | steps. | most process steps. | Defined process for |
| | appropriate | No defined | Resulting in | cross training and |
| | forecasting | process for | occasional volume | deployment during |
| | resulting in | engagement | variations | stretch periods. |
| | perpetual | during volume | (slack/stretch). | As a result, no |
| | slack/stretch in | variations (that | Plan for managing | slack/stretch in any |
| | most process steps. | cause | volume variations | process steps. |
| | No defined process | slack/stretch). | (that cause | |
| | for engagement | | slack/stretch), and | |
| | during volume | | is followed. | |
| | variations (that | | | |
| | cause | | | |
| | slack/stretch). | | | |
| Standard | Senior | Senior | Senior | Senior management |
| Work | Management - | management | management sets | sets direction and |
| | strategic decision | sets direction | direction and | strategy with |
| | not cascaded/no | and strategy | strategy with | feedback loops. |
| | feedback loops. | using feedback | feedback loops. | Middle |
| | | loops. | Middle | management solves |
| | | Middle | management | horizontal cross |
| | | management | solves horizontal | cutting problems |
| | | unable to solve | cross cutting | with A3. |
| | | horizontal cross | problems with A3. | Frontline |
| | | cutting | Frontline | management |
| | | problems. | management | stabilizes processes |
| | | | unable to stabilize | and improves them |
| | | | processes and | through standard |
| | | | improve them | work and standard |
| | | | through standard | management. |
| | | | work and standard | Key people are |
| | | | management. | trained on VSM |
| | | | | and PDCA skills. |
| E-T-E | E-T-E matrices are | E-T-E matrices | E-T-E matrices are | E-T-E matrices are |
| Matrices | not defined. | are defined. | defined but not | defined and |
| | | There is no | published at | published at |
| | | governance | appropriate | appropriate |
| | | around E-T-E | frequency or not | frequency at all |
| | | matrices which | published at all | process steps. |
| | | will impact the | process steps | |
| | | Biz Metrics | which impacts the | |
| | | | BIZ metrics | |
| Visual | Abnormalities are | Abnormalities | Abnormalities are | Any abnormality is |
| Management | not known till an | are known but | known | immediately made |
| | escalation | not made | immediately but | visible (visual |
| | happens. | visible. | made visible after | management). |
| | | | a time lag. | |

For the purpose of performing the lean maturity assessment, the enterprise process is rated on the scale of 1-to-4 for each of the lean assessment parameters. Based on the scoring guidelines as provided in Table 1, a current scoring is provided for the current state of the enterprise process and a target scoring is provided for the target state of the enterprise process based on the lean assessment parameters. Further, each of the lean assessment parameters may be provided a weightage based on the enterprise process being evaluated.

Table 2 below provides a sample scoring of the enterprise process for the current state and the target stated based on the lean assessment parameters. Column ‘Lean Assessment Parameter’ provides the list of the lean assessment parameters as defined in column ‘Parameter’ of Table 1. Column ‘Weight’ provides a weightage of each of the lean assessment parameters. Column ‘Current State’ and ‘Target State’ provides a current scoring and a target scoring of the enterprise process based on the scoring guidelines mentioned in Table 1. For example, the enterprise process is provided the current scoring of ‘3’ and the target scoring of ‘4’ for the parameter ‘Valuable’. The scoring data received by the capturing module 120 may be further stored as the process data 128.

TABLE 2

| Lean Assessment | | Current | Target |
|---|---|---|---|
| Parameter | Weight | State | State |
| Purpose | 2 | 2 | 4 |
| Valuable | 3 | 3 | 4 |
| Capable | 3 | 2 | 4 |
| Available | 3 | 3 | 4 |
| Adequate | 3 | 2 | 4 |
| Flexible | 3 | 2 | 4 |
| Flow, Pull, Push | 3 | 2 | 3 |
| Leveling | 3 | 2 | 4 |
| Standard Work | 3 | 2 | 3 |
| E-T-E Matrices | 3 | 3 | 4 |
| Visual | 3 | 2 | 3 |
| Management | | | |

Upon receiving the process data 128, the analysis module 122 may calculate a plurality of lean metrics for each of the plurality of activities based on the process data 128. As would be understood, lean is a business methodology to identify wasteful practices, reduce costs, and increase quality of an enterprise process. Therefore, a user defines the lean metrics to objectively identify the wasteful practices of the enterprise process in terms of resources and activities employed in the enterprise process. Examples of such plurality of lean metrics include, but are not limited to, full time equivalent (FTE), input volume per month, touch points per unit of output volume, turn around time, actual defect count per month, value added (VA) FTE's & activities, non-value added (NVA) FTE's & activities, business non value added (BNVA) activities, regulatory non-value added (RVNA) activities, and unutilized FTE. FTE may be defined as unit that indicates the enterprise process. Input volume per month may be defined as a unit that indicates volume of input data received by the enterprise process. For example, number of insurance claim applications received in a month for an enterprise process pertaining to processing of such applications may be defined as input volume for the month. Touch points per unit of output volume may be defined as number of interaction's where end customers and business users engage to exchange information, provide service, or handle transactions. Turn around time may be defined as total time required for creation of deliverable for an end customer. Actual defect count per month may be defined as number of defective deliverables detected in a month during a creation of deliverables in the month. VA activities may be defined as a sequence of activities for which the end customer is willing to pay and resulting in service or a deliverable which is produced efficiently. VA FTE may be defined as number of employees (full time equivalent) working on value added activities. NVA activities may be defined as activities which do not contribute to creation of a service or a deliverable efficiently and also do not add any business value for the end customer. NVA FTE may be defined as number employees (full time equivalent) working on non-value added activities. BNVA may be defined as activities needed to support the internal business/management needs. RNVA may be defined as activities undertaken to comply with compliance regulation. Unutilized FTE may be defined as number of full time equivalent employees who are not working(or waiting for work) on VA and NVA activities beyond the allowable break, meeting, huddle time. The calculated plurality of lean metrics may be stored as the analysis data 130.

After calculating the plurality of lean metrics, the assessment module 124 may perform a lean maturity assessment of the enterprise process by comparing the current state of the enterprise process with the target state of the process. The lean maturity assessment enables the user to assess an advancement of the enterprise process in terms of the lean assessment parameters for reaching the target state of the enterprise process such that business objectives and end customer satisfaction is achieved. In an implementation, the assessment module 124 may evaluate a lean maturity score of the enterprise process based on the current scoring and the target scoring received by the capturing module 120 to assess the current state and target state of the enterprise process. For example, the assessment module 124 may evaluate the lean maturity score based on the current scoring and the target scoring as provided in the Table 2. The assessment module 124 may also generate a chart depicting the current state and the target state in a graphic form. In one example, the chart may be a radar chart as illustrated in FIG. 1b.

FIG. 1b illustrates a radar chart 136 based on the sample lean assessment scoring provided in the Table 2. As illustrated in FIG. 1b, the radar chart 136 indicates scoring of the enterprise process for each of the lean assessment parameter to depict the lean maturity assessment of the enterprise process by way of scoring. Curves 138 and 140 depict the current scoring and the target scoring of the enterprise process for each of the lean assessment parameters as provided in Table 2.

Further, the assessment module 124 may generate a value stream analysis map illustrating the current state of the enterprise process based on the process data and the calculated plurality of lean metrics. The values stream analysis map may also provide the calculated plurality of lean metrics parameters for each of the plurality of activities. The assessment module 124 may further generate one or more performance analysis charts for illustrating the current state of the enterprise process. The performance analysis charts may be generated based on the calculated plurality of lean metrics for providing value added and non-value added (VA/NAV) analysis and lean time analysis. Examples of such performance analysis charts include, but are not limited to, FTE based study, VA/NVA analysis in terms of FTE, process utilization chart, and production chart. The performance analysis charts may be stored as the assessment data 132. Based on the assessment data 132, the user may evaluate the enterprise process to identify strengths and weakness of the current state of the enterprise process impacting key performance indicators of the business. Also, the user may identify improvements to improve the enterprise process for meeting business objectives and improving end customer satisfaction.

FIG. 1c illustrates an example of one performance analysis chart, such as FTE based study chart 142. The FTE based study chart 142 provides information about FTE taken into consideration or accounted for during the evaluation process. In the example, FTE based study chart 142 is provided as a pie chart. A portion 144 indicates a percentage of the FTE accounted for during the evaluation process, while a portion 146 indicates a percentage of FTE not accounted for during the evaluation process.

FIG. 1d illustrates example of another performance analysis chart, such as VA/NVA analysis in terms of FTE chart 148. The VA/NVA analysis in terms of FTE chart 148 provides information about FTEs who are currently accounted for Value generating activities and NON-value generating activities. The VA/NVA analysis in terms of FTE chart 148 further provides information about reducing the NON-value generating activities and reducing the FTE effort or headcount in order to improve process efficiencies. In the example, VA/NVA analysis in terms of FTE chart 148 is provided as a bar chart. In the VA/NVA analysis in terms of FTE chart 148, the NVA activities are shown as RNVA, BNVA & NVA activities along the horizontal axis 150 labeled as ‘activities’. The FTE required against each of the activities is represented along the vertical axis 152 labeled as ‘FTE’.

FIG. 1e illustrates an example of yet another performance analysis chart, such as lean cycle time analysis chart 154. The lean cycle time analysis chart 154 provides how much of time is involved in activities which are not value adding to the end customer, yet still form a part of the enterprise process. The lean cycle time analysis chart 154 represents all the business wastes and provides a business case for improvements to be deployed for immediate deployment towards reduction of business waste. In the example, the lean cycle time analysis chart 154 is provided as a bar chart. In the lean cycle time analysis chart 154, each of the lean process waste is provided along a horizontal axis 156 labeled as ‘Lean Process Waste’. The total number of hours invested in all activities including waste activities is provided along a vertical axis 158 labeled as ‘Time (Hours)’.

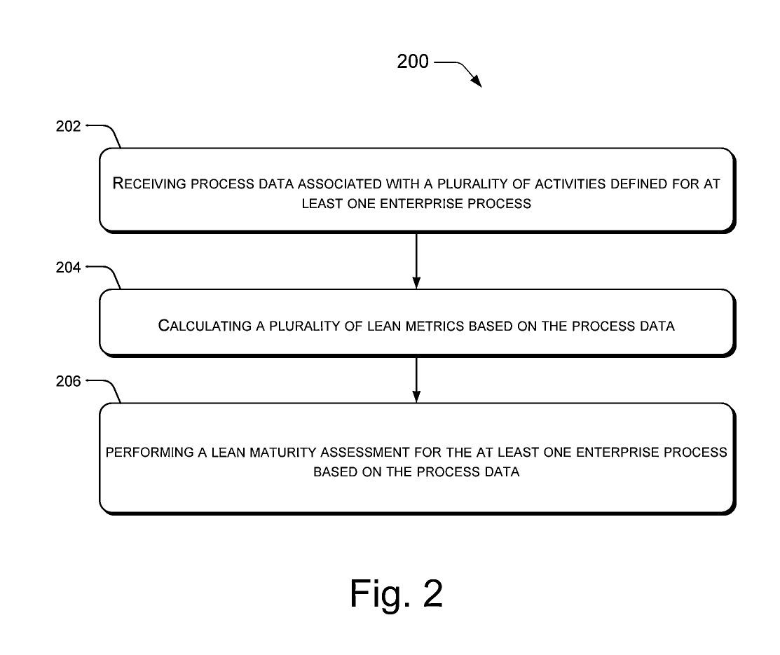

Thus, the performance analysis charts such as the FTE based study chart 142, the VA/NVA analysis in terms of FTE chart 148, and the lean cycle time analysis chart 154 enable a user to readily analyze the FTE utilization required for an enterprise process and identify improves to reduce FTE wastage for improving enterprise process efficiencies. Also, the performance analysis charts enables the user to identify possible improvement opportunities in resource through training to improve their skill set. Further, the user is able to identify the any RNVA and BNVA activities which are not compliance driven and may be eliminated to improve enterprise process efficiencies and meet business objectives. FIG. 2 illustrates a method 200 for performing evaluation of an enterprise process pertaining to a business, in accordance with an implementation of the present subject matter. The method 200 may be described in the general context of computer executable instructions. Generally, computer executable instructions may include routines, programs, objects, components, data structures, procedures, modules, functions, etc., that perform particular functions or implement particular abstract data types. The method 200 may also be practiced in a distributed computing environment where functions are performed by remote processing devices that are linked through a communications network. In a distributed computing environment, computer executable instructions may be located in both local and remote computer storage media, including memory storage devices. The method described herein may be implemented by computer-executable instructions in one or more computer-readable media (for example, computer storage media or other tangible media). Further, the method described herein may be implemented in a plurality of programming languages.

The order in which the method 200 is described is not intended to be construed as a limitation, and any number of the described method blocks may be combined in any order to implement the methods, or alternative methods. Additionally, individual blocks may be deleted from the method 200 without departing from the spirit and scope of the subject matter described herein. Furthermore, the methods may be implemented in any suitable hardware, software, firmware, or combination thereof.

At block 202, process data about the enterprise process is received based on a template. In one implementation, the process data is mapped with a plurality of activities associated with the enterprise process. For example, the capturing module 120 may receive the process data 128 for the enterprise process from a user.

At block 204, a plurality of lean metrics is calculated based on the process data. In one implementation, plurality of lean metrics is calculated for each of the plurality of activities based on the process data. Examples of such plurality of lean metrics include, but are not limited to, full time equivalent (FTE), input volume per month, touch points per unit of output volume, turn around time, actual defect count per month, value added (VA) activities, non-value added (NVA) activities, business non value added (BNVA) activities, regulatory non-value added (RVNA) activities, and unutilized FTE. For example, the analysis module 122 may calculate a plurality of lean metrics for each of the plurality of activities based on the process data 128.

At block 206, a lean maturity assessment is performed for the enterprise process based on the process data. In one implementation, the lean maturity assessment of the enterprise process is performed by comparing the current state of the enterprise process and a target state of the enterprise process. For this purpose, the enterprise process is rated for each of a plurality of lean assessment parameters. In one example, the enterprise process is rated for eleven parameters namely, Purpose, Valuable, Capable, Available, Adequate, Flexible, Leveling, Standard Work, End-To-End Matrices, Visual Management, and Flow, Pull, Push. Each of the eleven parameters may be provided a weight based on the enterprise process being assessed. A 1-to-4 scoring is used to assess the enterprise process for each of the eleven parameters, where 1 represents the lowest level of scoring and 4 represents best in class. Based on scoring criteria and the process data, a current scoring for the current state of the enterprise process and a target scoring for a target state of the enterprise process is received from the user. Based on the current scoring and the target scoring, a lean maturity score may be evaluated and a chart depicting the current scoring and the target scoring in a graphic form is generated. For example, the capturing module 120 may receive the current scoring and the target scoring of the enterprise process based on the process data and the scoring criteria from the user. Based on the current scoring and the target scoring of the enterprise process, the assessment module 124 may evaluate a lean maturity score and generate a chart depicting the current scoring and the target scoring. The lean maturity score may be used by business users for identifying improvements in the enterprise process to achieve the target state of the enterprise process.

Although embodiments for performing evaluation of an enterprise process have been described in language specific to structural features and/or methods, it is to be understood that the invention is not necessarily limited to the specific features or methods described. Rather, the specific features and methods are disclosed as exemplary embodiments for enterprise process evaluation.

I/We claim:

1. A computer implementable method for performing evaluation of at least one enterprise process, the method comprising:
receiving, by a capturing module, process data pertaining to a plurality of activities associated with the at least one enterprise process through a template, wherein the process data depicts a current state of the at least one enterprise process and wherein the current state depicts present working condition of the enterprise process;
calculating, by an analysis module, a plurality of lean metrics for each of the plurality of activities based on the process data, wherein the plurality of lean metrics include at least one of full time equivalent (FTE), input volume per month, touch points per unit of output volume, turn around time, actual defect count per month, value added (VA) activities, non-value added (NVA) activities, business non value added (BNVA) activities, regulatory non-value added (RVNA) activities, and unutilized FTE; and
comparing, by an assessment module, the current state of the at least one enterprise process with a target state of one enterprise process based at least on the process data and target data depicting the target state of the at least one enterprise process to perform a lean maturity assessment of the at least one enterprise process, wherein the target state depicts a future condition of the at least one enterprise process, and wherein the lean maturity assessment is performed for evaluating the at least one enterprise process.

2. The method as claimed claim 1, wherein the method further comprises generating, by the assessment module, a value stream map based on the process data and the calculated plurality of lean metrics, wherein the value steam map illustrates the current state of the at least one enterprise process for evaluating the at least one enterprise process.

3. The method as claimed claim 1, wherein the method further comprises generating, by the assessment module, at least one chart based on the calculated plurality of lean metrics, wherein the at least one chart illustrates the current state of the at least one enterprise process for evaluating the at least one enterprise process.

4. The method as claimed in claim 1, wherein the method further comprises receiving, by the capturing module, a current scoring for the current state of the at least one enterprise process, for each of a plurality of lean parameters.

5. The method as claimed in claim 1, wherein the method further comprises receiving, by the capturing module, a target scoring for the target state of the at least one enterprise process for each of the plurality of lean assessment parameters.

6. The method as claimed claim 1, wherein performing the lean maturity assessment further comprises evaluating, by the assessment module, a lean maturity score for the at least one enterprise process based on the current scoring and the target scoring to evaluate the at least one enterprise process.

7. The method as claimed claim 6, wherein performing the lean maturity assessment further comprises generating, by the assessment module, a chart illustrating the current state and the target state of the at least one enterprise process based on the current scoring and the target scoring to evaluate the at least one enterprise process.

8. The method as claimed in claim 1, wherein the method further comprises providing at least one prompt illustrating a sample data for receiving the process data associated with the plurality of activities.

9. The method as claimed in claim 1, wherein the process data includes at least one of business metrics, actual headcount, inventory, turn around time, defect rate, service level agreements, systems for performing the at least one enterprise process, applications for performing the at least one enterprise process, data input forms, data output forms, improvement opportunity, and process key performance indicators.

10. The method as claimed in claim 9, wherein the business metrics include customer, output definition, output volumes per month, supplier, actual headcount, and a time period.

11. A process evaluation system for performing evaluation of at least one enterprise process, the process evaluation system comprising:
a processor;
a capturing module coupled to the processor to receive process data associated with a plurality of activities defined for the at least one enterprise process through a template, wherein the process data depicts a current state of the at least one enterprise process and wherein the current state depicts present working condition of the at least one enterprise process;
an analysis module coupled to the processor to calculate a plurality of lean metrics for each of plurality of activities based on the process data, wherein the plurality of lean metrics include full time equivalent (FTE), input volume per month, touch points per unit of output volume, turn around time, actual defect count per month, value added (VA) activities, non-value added (NVA) activities, business non value added (BNVA) activities, regulatory non-value added (RVNA) activities, and unutilized FTE; and
an assessment module coupled to the processor to perform a lean maturity assessment of the at least one enterprise process based at least on the process data and a target data depicting a target state of the at least one enterprise process to evaluate the at least one enterprise process, wherein the target state depicts a future condition of the at least one enterprise process.

12. The process evaluation system as claimed in claim 11, wherein the assessment module further performs the lean maturity assessment by comparing the current state of the at least one enterprise with the target state of the at least one enterprise process.

13. The process evaluation system as claimed in claim 11, wherein the capturing module further:
receives a current scoring for the current state of the at least one enterprise process for each of a plurality of lean parameters; and
receives a target scoring for the target state of the at least one enterprise process for each of the plurality of lean parameters.

14. The process evaluation system as claimed in claim 13, wherein the assessment module further:
evaluates a lean maturity score for the at least one enterprise process based on the current scoring and the target scoring to evaluate the at least one enterprise process;
generates a chart illustrating the current state and the target state of the process based on the current scoring and the target scoring to evaluate the at least one enterprise process;
generates a value stream map based on the process data and calculated plurality of lean metrics, wherein the value steam map illustrates the current state of the at least enterprise process to evaluate the at least one enterprise process; and
generates at least one chart based on the calculated plurality of lean metrics, wherein the at least one chart illustrates the current state of the at least one enterprise process to evaluate the at least one enterprise process.

15. A non-transitory computer readable medium having a set of computer readable instructions that, when executed, cause a computing system to:
receive process data for a plurality of activities associated with the at least one enterprise process through a template, wherein the process data depicts a current state of the at least one enterprise process and wherein the current state depicts present working condition of the at least one enterprise process;
calculate a plurality of lean metrics for each of the plurality of activities based on the process data, wherein the plurality of lean metrics include full time equivalent (FTE), input volume per month, touch points per unit of output volume, turn around time, actual defect count per month, value added (VA) activities, non-value added (NVA) activities, business non value added (BNVA) activities, regulatory non-value added (RVNA) activities, and unutilized FTE; and
compare the current state of the at least one process with a target state of the at least one enterprise process based at least on the process data and target data depicting the target state of the at least one enterprise process to perform a lean maturity assessment of the at least one enterprise process, wherein the target state depicts a future condition of the at least one enterprise process, and wherein the lean maturity assessment is performed for evaluating the at least one enterprise process.
